(19) United States
(12) Patent Application Publication
(10) Pub. No.: US 2017/0195091 A1
(43) Pub. Date: Jul. 6, 2017

(54) TRANSPORTATION SYSTEM WITH GUIDES FOR GUIDED TRANSPORTATION VEHICLES AND METHOD FOR OPERATING SAID TRANSPORTATION SYSTEM

(71) Applicant: Holger Cremer, Duesseldorf (DE)

(72) Inventor: Holger Cremer, Duesseldorf (DE)

(73) Assignee: DEMATIC ACCOUNTING SERVICES GMBH, Offenbach (DE)

(21) Appl. No.: 13/805,536

(22) PCT Filed: Jun. 28, 2011
(86) PCT No.: PCT/EP2011/060840

§ 371 Date: Jan. 15, 2013

(30) Foreign Application Priority Data
Jul. 6, 2010 (DE) 102010030998.2

(51) Int. Cl. H04L 5/00; B61L 1/02; B61L 23/20

(52) U.S. Cl. CPC H04L 5/0001; B61L 23/20; B61L 1/02; B61L 2205/00; B61L 2210/00

(57) ABSTRACT

Transportation system with guides for guided transportation vehicles, wherein the transportation vehicles are supplied with electrical power via a contact line, wherein the transportation vehicles are also supplied with data from a control unit via the same contact line.

### CROSS REFERENCE TO RELATED APPLICATION

The present application claims the priority benefits of International Patent Application No. PCT/EP2011/060840, filed on Jun. 28, 2011, which is hereby incorporated herein by reference in its entirety.

### BACKGROUND OF THE INVENTION

The present invention relates to a transportation system with guides for guided transportation vehicles, wherein the transportation vehicles are supplied with electric current via a contact line, and relates to a corresponding operating method.

From EP 1 254 852 B1 a storage and transportation system is known having transportation vehicles which can travel on railway tracks, so-called satellite vehicles or shuttles which are controlled by a control computer via a wireless connection (WLAN). The vehicles are supplied with current either via contact lines or by induction.

The use of WLAN technology has the advantage that absolutely no hardware has to be installed on the railway tracks themselves and the constantly moving satellite vehicles can always be reached or can communicate wirelessly. However, for this purpose each vehicle must carry a WLAN adaptor.

However, WLAN communication suffers from the system-imposed disadvantage that it is dependent on the topology of the site. This leads to a reduction in the availability of the site and makes projects more expensive. Furthermore, a WLAN system must always be planned and commissioned anew from site to site. A plug & play solution is not readily possible with WLAN technology.

Although the construction of large WLANs with a plurality of base stations and uninterrupted switching of the clients between the different base stations is provided as standard, in practice there are problems. The frequency ranges of the base stations may overlap and lead to interference. Since—in contrast to mobile telephone networks—the “intelligence” resides entirely within the client, there is no true handover between different base stations. In normal operation, a client will seek a new base station only when contact with the previous one has already been broken off. Owing to the limited number of freely available WLAN channels, the size of sites has thus far been limited because replication of a channel has a negative effect on the site availability and causes interference. In addition, there are limitations, depending on the country concerned, on the number of free WLAN channels. Moreover, site operators themselves very often use WLAN technology in other applications, which then renders use in the transportation system more difficult or impossible.

Although power rail-bound data transmissions exist, this technology tends to suffer from interference.

Thus, from DE 100 59 072 A1, a device for transmitting binary data between two participants, which can move relative to each other, via a contact line is known. Transmission data of a transmitting participant reach the contact line via an energy-amplifying line coupler and the contact line is open at its ends. The frequency content of the transmission data reaching the contact line is limited to a degree which is permissible in dependence upon a preset maximum data transmission rate and the contact line is formed as an electrically short line in relation to the limited frequency content of the transmission data. This contact line, however, is used only for data transmission.

It is also known to use power lines in private households for data transmission for computers. This technology, also called PowerLAN or Powerline communication (PLC), designates a local area network which also uses lines intended for supplying conventional network voltage for data transmission. This is a carrier frequency system which is produced by adaptors. By means of a carrier frequency system (CFS) a plurality of signals are each additionally modulated on the line to a carrier frequency (frequency division multiplex process) and distributed on the line. By means of a band pass filter the frequencies are then separated from the carrier frequencies at the receiving adapter.

Furthermore, this is a matter of communication in which the network is measured prior to the beginning of the transmission of data by modem tuning. Only in this way is it possible to have any success at all in using the open domestic network, to which a wide variety of consumers are connected at a wide variety of locations.

Conductors through which current is flowing, however, act as antennas and emit the CFS signals into the surrounding area. Since a power line without shielding also receives signals from the surrounding area and from connected devices, there is a problem that in order to maintain a good connection, high transmission levels of the CFS modems are required. High transmission levels of the modems, however, lead to higher emitted signals.

### SUMMARY OF THE INVENTION

In contrast, the present invention provides a simple way of transmitting data between rail-bound transportation vehicles and a (central) control computer. In particular, a current supply and secure data transmission at the same time should easily be possible.

A transportation system with guides for guided transportation vehicles, wherein the transportation vehicles are supplied with electric current from a current feed of a power network via a contact line, according to an aspect of the invention, includes a control unit. The transportation vehicles are supplied with data from a data feed from the control unit via the contact line. The contact line is divided into a plurality of sections for data supply from the control unit to the transportation vehicles. One or more of the transportation vehicles is located in each of the sections at one time. Each of the sections is supplied with data from the control unit for only the transportation vehicle(s) in that one of the sections.

Owing to the fact that the transportation vehicles are also supplied with data from a control unit via the same contact line, a particularly simple data transmission or supply of data is possible without additional installations on the contact lines or guides, etc. Each vehicle and the central control merely have to be provided with a corresponding interface adapter.

The contact line is divided into sections for the supply of data, wherein only one or a plurality of transportation vehicles are located in each section at one time and each section is supplied only with the data for the respective transportation vehicles. It is possible, in spite of brush arcing during “collection” of the current or of the data from the contact line, to provide successful and secure data transmission between a plurality of rail-bound transportation vehicles and a central control computer.

It is thus possible for the transportation vehicles to share sections or to change sections. Thus, provision can be made for the transportation vehicles to use lifts or points in order to leave sections and to change to other sections. The addressing of the data to the contact lines of the corresponding lifts, points, etc., for a group of transportation vehicles can then take place so that these sections are ready with the corresponding data as soon as a transportation vehicle uses them.

One embodiment includes only one individual transportation vehicle per contact line section at one time.

The division of the contact line into sections means that, in spite of the moving vehicles and therefore the changing line length and thus changing network topology, virtual point-to-point communication is made possible.

A contact line is in this case understood to be a power rail as a supply line for the electric current for the electric drive of the transportation vehicles. The current supply from the power rail to the transportation vehicle is effected via so-called contact shoes or current collectors.

Electric current is in this case understood to be the electric current for supplying the electric travel drives of the transportation vehicles, e.g., electric motors. This may be alternating current and in particular in the range between 40 V to 220 V, in the range between 40 V and 110 V. It is also possible to use direct current.

In spite of the division of the contact line into a plurality of sections, it is possible for a plurality of sections to have a parallel feed from the same current source. The division into sections relates only to the data feed which is effected in a targeted/addressed manner into the respective contact line section. The supply of current can thus be effected in a centralized or grouped manner.

In order to prevent undesired crosstalk of the data—addressed in a targeted manner—from the data transmission from one contact line section into other non-addressed contact line sections, a filter device may be connected between the current feed and the data feed of each contact line section to prevent crosstalk of the data signals into the power network. The filter may be an inductor and/or a capacitor or only an inductor. The filter device thus filters the data signals out of the current supply.

The transportation system may include a device for targeted modulation of the data to the current supply for the supply of a specific transportation vehicle in a contact line section and in each vehicle a device is provided for demodulation of the data from the supply current. The data for the respective transportation vehicle are thus sent (modulated) in an addressed or targeted manner via the device to the respective contact line section, on which the corresponding transportation vehicle is located. The device for targeted modulation functions in a similar manner to a switch from conventional Ethernet technology.

The device for targeted modulation thus stores the respective stopover place of a transportation vehicle, i.e., the contact line section. This can be effected in a self-learning and automatic manner or can be programmed. The communication from the device for targeted modulation then takes place directly via the respective contact line sections. The back-communication from the transportation vehicle is correspondingly “simpler” since only one path, namely, the respective contact line section, is available.

Of course, it is possible, however, to carry out a data transmission simultaneously into all sections or section groups, etc., in the manner of a broadcast signal.

The guides may be railway tracks and the transportation vehicles are rail-bound transportation vehicles. However, other guides can also be used. Thus, e.g., laterally limited travel paths for the transportation vehicles can also be used as guides. Even the contact line itself could be used as a guide.

In order to increase the security and redundancy of the data transmission, the transmitted net data transmission rate of the contact line is low yet the gross data transmission rate is high enough to transmit the required quantity of data. Therefore, in spite of the considerable interference, e.g., owing to brush arcing, secure transmission can be ensured.

The net data transmission rate may be between 20 and 50 kBaud.

Thus, contrary to the prevailing manner of progressing to ever more high-performance and higher transmission rates, the opposite path towards lower transmission rates is possible.

The transmission properties (speed and redundancy) selected for secure data transmission during transportation can be changed for so-called offline operation (no communication to the control computer) e.g., program download. If it is assumed that, for example, the program download is carried out when the transportation vehicle is at a standstill, it is not necessary to take account of expected interference owing to brush arcing. Therefore, the transmission redundancy of the protocol can be reduced, which would bring with it an increase in the net data transmission speed. Therefore, when the transportation vehicles are at a standstill, it is possible also to transmit larger quantities of data, e.g., during an update of the firmware of the transportation vehicles, to the transportation vehicles.

Therefore, the method in accordance with an embodiment of the invention can also be used in offline operation with reduced transmission redundancy and/or an increased data transmission rate in order to effect an increase in the net data transmission speed to the stationary transportation vehicles.

The data transmission method can be used not only for pure data transmission, but also as a method for measuring the quality of the current collectors. If the transmission quality deteriorates owing to increased brush arc formation, the data transmission speed is also reduced which means that many data packets must be transmitted repeatedly. Therefore, the data rate which can therefore be used as a measuring variable for the quality of the current transmission is reduced. The method in accordance with the invention can therefore also be used as a method for measuring the quality of the current collectors of the transportation vehicles. The transmission quality is monitored and deterioration therein serves as a measurement for the wearing out of the current collectors.

The transportation system may be provided with railway tracks and rail-bound transportation vehicles are used.

The system and method in accordance with an embodiment of the invention can be used particularly in in-house logistics applications. For example, this embodiment may be used in storage and transportation systems having one or a plurality of levels with associated conveyor technology, racks, workstations, etc.

In such storage and transportation systems, a rail-bound transportation vehicle in the rack, for example, serves the whole storage system. The system design may be based on autonomous, rail-guided vehicles for transportation of pallets, containers, trays, cardboard boxes, packing drums or other goods, including direct transportation of goods without loading aids, which operate inside and outside the storage system. A special load-receiving means permits short load-change times and simultaneous loading and unloading. The system has travel rails which can be installed on each level of the store or standing upright or suspended in the preliminary zone. By means of highly dynamic lifts, the vehicles or levels change. Both the power and also the “orders” are received by the transportation vehicles via the contact line-related current and data transmission in accordance with embodiments of the invention.

However, the transportation vehicles can also be racking storage and retrieval vehicles, racking serving devices, distribution and travelling trucks and other rail-bound conveying systems.

### BRIEF DESCRIPTION OF THE DRAWING

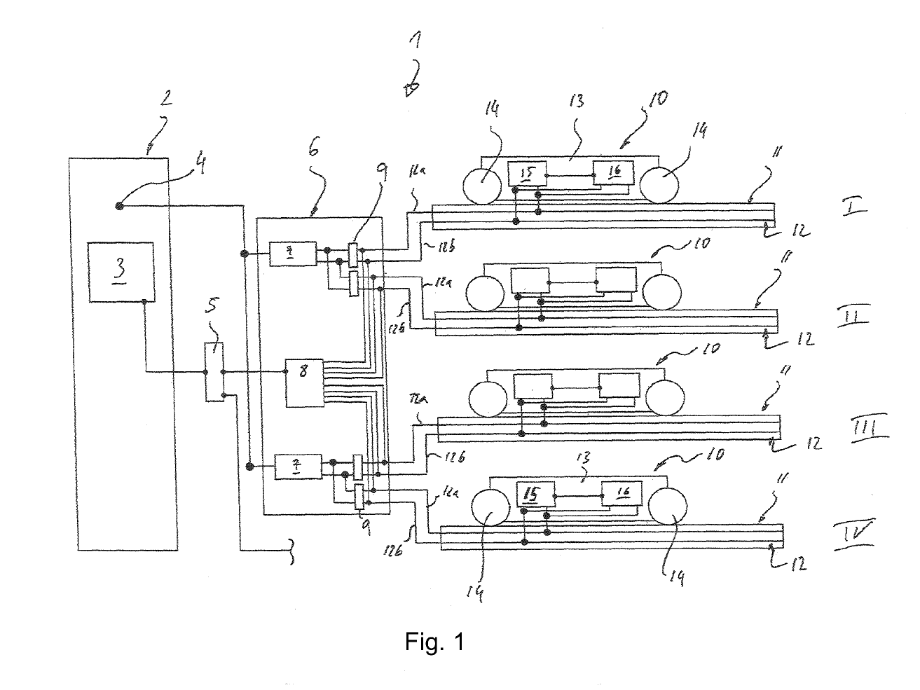

Further details, features and advantages of the invention will become clear from the following description of an exemplified embodiment with the aid of the single drawing (FIG. 1) which shows a block diagram of a transportation system with guided transportation vehicles and their current and data supply via a contact line.

### DESCRIPTION OF THE PREFERRED EMBODIMENT

In FIG. 1 the transportation system is designated as a whole by 1. It includes central control and current supply electronics 2 which are integrated into a control cabinet. This has a central control 3 for control of the transportation vehicles and a central current feed 4 for supplying the system with electric power.

Guided transportation vehicles 10 are rail-bound satellite vehicles which travel on a respective level I, II, III, IV of an aisle of a rack on travel rails 11, disposed at that location between the sides of the rack, and are guided by rails 11.

In the region of the travel rails 11 contact lines 12 are disposed which are contacted by the transportation vehicles 10 by means of collectors in order to receive current and data. In the present example, 24 V of direct current are fed to the contact lines 12, meaning that these have two cables 12a, b.

The transportation vehicles 10 have, in addition to the wheels 14 and the current collector, not shown for the sake of clarity, a unit 15 for data extraction from the tapped current and an intelligent programmable control 16 which converts the “orders”, travel commands, etc., obtained from the extracted data. It will be understood that the unit 15, in addition to the demodulation of the data from the current, can also modulate data in order to transmit data from the transportation vehicle 10 to the central control 3.

The intelligent programmable control 16 is supplied in parallel directly with the tapped current in order to power, for example, on-board electronics and the travel drives.

The current supply to the individual sections of the contact lines of the respective levels I, II, III, IV takes place in parallel via network parts 7 which are supplied from the central current feed 4 and are disposed in a sub-distributor 6.

A single section-wise current supply to the contact line sections or even a common current supply are also feasible. This depends on the respective circumstances, e.g., length of the sections, type of transportation vehicles, etc.

In a sub-distributor 6, a unit or device 8 is also provided which, on the one hand, is connected via an Ethernet switch 5, which uses known technology, to the central control 3 and, on the other hand, divides the contact line into sections I, II, III, IV for the purpose of the targeted transmission of data to a specific transportation vehicle 10, wherein only one transportation vehicle 10 is located in each section I, II, III, IV at one time and each section I, II, III, IV is supplied only with the data for the respective transportation vehicle 10.

The unit 8 is, for this purpose, connected to the respective contact lines 12a, b of a section I, II, III, IV via dedicated lines and addresses these lines in a targeted manner by reason of the address of each transportation vehicle 10 analogously to a computer network. Therefore, the data are transmitted from the central control 3 via the switch 5 to the unit 8 by means of the Ethernet protocol and at that location are converted into the protocol used to communicate via the contact line 12. The address of the transportation vehicle 10 intended to receive the data, are fed in a targeted manner into the contact line 12 of the respective section I, II, III, IV or modulated to the current. It will be understood that the reverse path is also possible.

The data are then extracted or demodulated from the tapped current by the respective transportation vehicle 10 of the corresponding section I, II, III, IV by means of the demodulated unit 15. These data are then passed to the intelligent programmable control 16. It will again be understood that the reverse path is also possible.

The unit 8 for targeted modulation thus stores the respective stopover place of a transportation vehicle 10, i.e., the contact line section I, II, III, IV. This can be carried out in a self-learning and automatic manner or can be programmed. The communication from the unit 8 then takes place directly via the respective contact line sections. The back-communication from the transportation vehicle 10 is correspondingly “simpler” since only one path, namely, the respective contact line section, is available.

Of course, it is also possible, however, to carry out the data transmission simultaneously into all sections I, II, III, IV or section groups, etc., in the manner of a broadcast signal.

In order to increase the security and redundancy of the data transmission, the transmitted net data transmission rate of the contact line is so low yet the required gross data transmission rate is high enough to transmit the required quantity of data. Therefore, in spite of the considerable interference, e.g., owing to brush arcing, a secure transmission can be ensured. The net data transmission rate is between 20 and 30 kBaud (higher in offline operation). The use of this data transmission rate, which is very low by today's standards, is possible because, amongst other things, the transportation vehicles 10 include the intelligent programmable control 16 which only has to be supplied with orders but monitors and carries out low operational functions independ-ently. The intelligent programmable control 16 also contains, e.g., a type of system map so that the transportation vehicle 10 knows where it is located and where it must travel to in order to carry out an order.

In order to prevent undesired crosstalk of the data—addressed in a targeted manner—from the data transmission from the contact line 12 of one section I, II, III, IV into other non-addressed contact line sections, a filter device 9 is connected between the current feed via the network parts 7 and the data feed of each contact line section via the unit 8. The filter device includes, for this purpose, one inductor per cable 12a, b or phase and one capacitor connecting the cable 12a, b. The filter device 9 thus filters the data signals out of the current so that they cannot be propagated via the “open” current supply.

1. Transportation system with guides for guided transportation vehicles, wherein the transportation vehicles are supplied with electric current from a current feed of a power network via a contact line, said transportation system comprising:
a control unit, wherein the transportation vehicles are supplied with data from a data feed from said control unit via said contact line;
wherein said contact line is divided into a plurality of sections for data supply from said control unit to said transportation vehicles, wherein at least one of said transportation vehicles is located in each of said sections at one time and each of said sections is supplied with data from said control unit for only the at least one of said transportation vehicles in that one of said sections.

2. (canceled)

3. Transportation system as claimed in claim 1 wherein only one of said transportation vehicles is located in each of said sections at one time and each of said sections is supplied with the data from said control unit for the only one of said transportation vehicles in that one of said sections.

4. Transportation system as claimed in claim 1 wherein a plurality of said sections have a parallel said current feed from said current source.

5. Transportation system as claimed in claim 1 including a filter device that is connected between the current feed and the data feed of each of said sections of said contact line to prevent the data signals from coupling over to the power network.

6. (canceled)

7. Transportation system as claimed in claim 1 including a modulation device for targeted modulation of the data to the electric current for the supply to a specific one of said at least one of said transportation vehicles in one of said sections of said contact line and a demodulation device in each of said at least one of said transportation vehicles for demodulation of the data from the electric current.

8. (canceled)

9. Transportation system as claimed in claim 1 including a net data transmission rate of the contact line that is low yet a gross data transmission rate is high enough to transmit a required quantity of data.

10. (canceled)

11. Method for operating and controlling a transportation system with guides for guided transportation vehicles wherein the transportation vehicles are supplied with electric current from a current feed of a power network via a contact line, wherein the transportation vehicles are also supplied with data from a control unit via the same contact line, wherein said contact line is divided into a plurality of sections for data supply from said control unit to said transportation vehicles, wherein at least one of said plurality of transportation vehicles is located in each section at one time and each of said sections is supplied with data from said control unit for only the at least one of said transportation vehicles in that one of said sections.

12. (canceled)

13. Method as claimed in claim 11 wherein only one of said transportation vehicles is located in each section at one time and each of said sections is supplied with the data for only the one of said transportation vehicles in that one of said sections.

14. Method as claimed in claim 11 wherein a plurality of said sections have a parallel said current feed from said current source.

15. Method as claimed in claim 11 wherein data transmission is effected by targeted modulation of the data to the electric current for the supply to a specific one of said at least one of said transportation vehicles in an addressed contact line in one of said sections and demodulation of the data from the electric current is effected in said at least one of said transportation vehicles.

16. Method as claimed in claim 11 wherein a net data transmission rate is low yet a gross data transmission rate is high enough to transmit a required quantity of data.

17. (canceled)

18. Method as claimed in claim 11 wherein crosstalk of the data transmission from one of said contact line sections to another of said contact line sections is prevented by a filter device.

19. The transportation system as claimed in claim 1 having at least one level of associated conveyor technology, racks and workstations.

20. The transportation system as claimed in claim 1 having at least one rack with rack bays disposed on both sides of an aisle on a plurality of levels and rails, extending along the levels of the rack in the aisles, for rail-bound transportation vehicles for supplying goods to, and removing goods from the rack bays.

21. The method as claimed in claim 11 in offline operation with reduced transmission redundancy and/or an increased data transmission rate in order to effect an increase in the net data transmission speed to the stationary transportation vehicles.

22. The method as claimed in claim 11 including measuring the wear of current collectors of the transportation vehicles, wherein data transmission quality is monitored and using deterioration of the data transmission as a measurement for wear of the current collectors.

23. Transportation system as claimed in claim 3 wherein a plurality of said sections have a parallel said current feed from said current source.

24. Transportation system as claimed in claim 3 including a filter device that is connected between the current feed and the data feed of each of said sections of said contact line to prevent the data signals from coupling over to the power network.

25. Method as claimed in claim 13 wherein a plurality of said sections have a parallel said current feed from said current source.

26. Method as claimed in claim 13 wherein the data transmission is effected by targeted modulation of data to the electric current for the supply to a specific one of said at least one of said transportation vehicles in an addressed contact line in one of said sections and demodulation of the data from the electric current is effected in said at least one of said transportation vehicles.
